(19) United States
(12) Patent Application Publication
(10) Pub. No.: US 2014/0278772 A1
(43) Pub. Date: Sep. 18, 2014

(54) LIVE BUYER DATABASE CONSTRUCTOR

(71) Applicant: P. Virenderanath Choudary, Hyderabad (IN)

(72) Inventor: P. Virenderanath Choudary, Hyderabad (IN)

(21) Appl. No.: 14/066,592

(22) Filed: Oct. 29, 2013

Related U.S. Application Data
(63) Continuation of application No. PCT/IN2013/000378, filed on Jun. 18, 2013.

(30) Foreign Application Priority Data
Mar. 18, 2013 (IN) 1165/CHE/2013

(51) Int. Cl. G06Q 30/02

(52) U.S. Cl. CPC G06Q 30/0202
USPC 705/7.31

(57) ABSTRACT

A system and method for construction of live buyer database which identifies live buyer where the live buyer intends to purchase the targeted service or product within a particular time period, determining a reward for the live buyer based on the information received, pro-viding the reward to the live buyer within the particular time period based on the genuinity of the live buyer.

### PRIORITY CLAIM

This application is a continuation application of PCT application PCT/IN2013/000378 entitled “Live. Buyer Database Constructor,” filed Jun. 18. 2013, which claims priority to application 1165/CHE/2013 entitled “Live Buyer Database Constructor,” filed in India on Mar. 18, 2013, the contents of both of which are herein incorporated by reference in their entirety.

### FIELD OF THE INVENTION

The present invention relates to construction of live buyer database, and more particularly, to a system and method of qualifying appropriate live buyers of any product of service.

### BACKGROUND OF THE INVENTION

In industry, the vast majority of business models focus on advertising, and promotions to attract buyers to their own products or services or those they represent.

Business entities attract customers directly by various forms of the advertisements. These advertisements result in a large spend per customer acquired. There is also no way of associating the spend to a specific purchase in many instances. Newer and smaller firms are at a disadvantage as their advertising budget cannot compete.

Further, older firms tend to be better placed in customer minds and receive direct contacts. The newer players cannot access customers directly as they are not contacted by the customer since these players are not established in the mind of the customer. Therefore smaller/newer firms are handicapped with attendant financial consequences.

The lead generation services offered by various web portals, directory services and the like are inadequate and lack quality since they just forward an in inquiry to a particular business entity further such inquiries are unverified of the intent of the purchasers.

To overcome the above problems, there is a need for a system and method for creation of a live buyer database of a particular product or service,

### SUMMARY OF THE INVENTION

In view of the foregoing, an object of the present invention is to provide a system and method for creation of a live buyer database of a particular product or service, wherein the live buyer identification system encourages live buyers to provide individual, specific demand information.

An exemplary embodiment of the invention is to provide a live buyer to a central server with a description of targeted product/service which live buyer intends to purchase along with specific features of the product/service. The live buyer or the central server specifies a time period in which the targeted product/service is to be purchased. In exchange for the information provided, the live buyer is offered a reward, such as a gift in any of the various forms for e.g. cash or redeemable coupon or choice of the live buyer with restriction to in terms of decided reward amount. The value of the reward may be based upon the amount and specificity of the information provided by the live buyer, and/or the value of this information to sellers, such as manufacturers, retailers, service providers and distributors. The reward is in exchange of the information provided by the live buyer and it is irrespective of which vendor he/she chooses to make his/her purchase.

Another aspect of the invention involves a method that includes the steps of receiving at least a description of a targeted service or product, where is the live buyer intends to purchase the targeted service or product within a particular time period, determining a reward for the live buyer based on the information received, providing the reward to the live buyer within the particular time period based on the genuinity of the live buyer.

Another aspect of the invention is to create the database of the live buyers which is not referred to specific company or brand but for an industry segment such as Real estate, Auto-mobiles, Insurance etc., Further, the said targeted product or service is being referred not only to one specific industry but it can be implemented to any kind of business or industry modes.

Further, the term “live” is a one, which is referred to buyer at the time of declaration, the buyer's intending to soon be a buyer of the service or product but has not made or acted on a purchase decision yet.

The above summary relates to only one of the many embodiments of the invention disclosed herein and is not intended to limit the scope of the invention, which is set forth in the claims herein. These and other features of the present invention will be described in more detail be-low in the detailed description of the invention and in conjunction with the following figures.

### BRIEF DESCRIPTION OF THE DRAWINGS

The present invention is illustrated by way of example and not by way of limitation, in the figures of the accompanying drawings and in which like reference numerals refer to similar elements and in which:

FIG. 1 is a block diagram overview of a live buyer identification system according to an exemplary embodiment of the present invention.

FIG. 2 is a flow chart process describing liver buyer database constructor according to one embodiment of the present invention.

FIG. 3 is a process flowchart illustrating one embodiment of a method of the present invention.

### DETAILED DESCRIPTION OF EMBODIMENTS

A system embodying the present invention receives intent data from a live buyer who intends to purchase a particular item within a particular time period. It should be understood that the term “item” need not be limited to goods, but could also include services, such as contractor services or transactions that do not require actual delivery and also the purchase of product or services through any computing device on internet or any other mediums.

The intent data includes a description of the item and may also include other information, such as a degree of certainty with which the live buyer intends to purchase the item, and a particular time period within, which the live buyer intends to purchase the item. The system determines a value of the intent data and identities a reward based on that value. In this manner, the live buyer may be rewarded for providing information about his intent to purchase one or more particular items. Thus, the information provided by a buyer shall be an accurate reflection of his/her purchase intent.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The following description of the preferred embodiment(s) is merely exemplary in nature and is in no way intended to limit the invention, its application, or uses.

This system overcomes the disadvantages of the prior art demand forecasting systems be cause live buyers are providing information about specific items that they individually intend to purchase in the immediate future. Thus, the actual demand information directly from the consumer is received, rather than a speculative demand forecast based on an analysis of general consumer trends and sales history.

An example of a system embodying, the present invention is illustrated in FIG. 1. A live buyer identification system 100 according to the present invention includes a hardware set 101 implemented as a processor, a programmed general purpose computer and communication port and a central server 102. In a web embodiment, for example, the central server 102 may comprise a Web server hosting a “portal” Web site or search engine. A database may be connected to the central server 102 via an Internet connection using a public switched telephone network (PSTN) or cable network. Connection may also be provided by dedicated data lines, cellular, Personal Communication Systems (“PCS”), satellite networks or an other means of networking communication. Using these components, the present invention provides a method and apparatus which allows the creation of a live buyer database of a particular product or service.

FIG. 2 is a process flowchart illustrating one embodiment of the method for developing live buyer database. In Step 201, the central server 102 receives live buyer data from a live buyer, wherein the live buyer self declares him/herself, where this data may include at least a unique identifier for the live buyer, such as a user name and password or a universally recognized/government issued personal identification number. Further, in step 202, the central server 102 receives company seeking to acquire database, further in step 203, preliminary registration of prospect completed, where the interest expressed by live buyer is accepted by the system. Further in step 203, the preliminary registration of prospect completed, wherein further in step 204, the prospect live buyer submits proof of purchase, and further in step 205, co-verification submission against the set conditions are validated in Step 206.

FIG. 3 is a process flowchart illustrating one embodiment of the method of the receiving a confirmation signal from the live buyer of the present invention. In step 301, the central server 102 receives live buyer data from a live buyer. This data may include at least a unique identifier for the live buyer, such as a user name and password or a universally recognized/government issued personal identification number. The data may also include the name of the live buyer. The central server 102 may request additional information such as contact information (e.g. street address, home address, e-mail address, telephone number, etc.), demographic information (e.g. location, income, age, etc. and shopping or purchasing habits. Upon receiving this live buyer data, the central server 102 creates a new record in the live buyer database illustrated in FIG. 1 to store the data.

In step 302, the central server 102 receives intent data from the live buyer. This data includes at least a description of an item the live buyer intends to purchase within a particular time period. The time period and/or the item description can be specified by the live buyer. For example, the live buyer may indicate an intent to purchase a car within five days. Alternatively, the central server 102 may specify the time period and/or the item description. The central server 102 may display a message such as “click here if you are going to buy a car within the next week” or“click here if you are going to buy a car within the next two weeks.” Live buyers would then click on the appropriate controls and provide data such as a payment identifier and specific product description. The system may also be that there is a human interface to the buyer at all on contact points.

In either embodiment discussed above, the intent data may include a degree of certainty with which the live buyer intends to purchase the item within the particular time. The live buyer may provide demographic information (e.g. street address and state, income level, and/or age) or a purchasing profile (e.g. the types of merchants the live buyer frequents, which may be online or retail shopping). This intent data is stored in the central server—live buyer data-base 102 illustrated in FIG. 1.

In Step 303, the central server 102 determines an appropriate reward based on the intent data received from the live buyer. In one embodiment, once the central server 102 determines a reward for which the live buyer is eligible, the central server 102 outputs the reward offer to the live buyer in step 304. In an alternate embodiment, the central server 102 may determine multiple rewards for which the live buyer is eligible and permit the live buyer to select one or more of the rewards. The re-ward will be processed once there is confirmation of actual purchase within the specified time period. For example, a live buyer's financial account may be credited a predetermined amount (i.e., the amount of the reward) if the central server receives a confirmation signal indicating that the live buyer purchased the item within the particular tittle period.

A preferred embodiment includes a step 305 in which the live buyer accepts the reward offer. The buyer may be prompted to input a valid address to which the reward may be delivered. Alternatively, the buyer may be directed to an e-commerce merchant's web page and provided with an electronic gift certificate redeemable for the selected reward.

The invention is herein described, by way of example wily, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

All headings and sub-headings are used herein for convenience only and should not be construed as limiting the invention in any way. The use of any and all examples, or exemplary language (e.g., “such as”) provided herein, is intended merely to better illuminate the invention and does not pose a limitation on the scope of the invention unless otherwise claimed.

No language in the specification should be construed as indicating any non-claimed element as essential to the practice of the invention.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination.

1. A method for providing one or more leads for one or more products or services for one or more customers to one or more sellers comprising the steps of:
receiving at one or more first computers from one or more second computers through one or more communication networks an indication from said one or more customers that said one or more customers intends to purchase at least one of the products or services within a time period, said indication comprising one or more characteristics of said at least one product or service that said one or more customers intends to purchase within said a time period;
determining a region within which said one or more customers intends to purchase said at least one product or service;
transmitting a commitment to pay an amount to said at least one customer if an indication is received that said one or more customers purchased said at least one product or service within said region within said time period from said one or more first computers through said one or more communication networks to said one or more second computers;
determining at least one offered product or service that is offered for sale within said region by at least one of said one or more sellers and that has one or more characteristics that matches at least one of said one or more characteristics of said at least one of the products or services that said one or more customers intends to purchase; and
providing at least one lead to said at least one of said one or more sellers that is offering for sale within said region said at least one matching offered product or service from said one or more first computers through said one or more communication networks to one or more third computers, said lead identifying said a one or more customers intending to purchase said at least one of the products or services.

2. A method for providing one or more leads for one or more products or services for one or more customers to one or more sellers as in claim 1 wherein said or more products or services is at least one of one or more members of a group consisting of a truck, a car, a motorcycle, an all-terrain vehicle, a product or service that is required to be registered with a governmental agency upon transfer of ownership wherein said one or more characteristics includes one or is more members of the group consisting of a model, a make, an options package, and a year of manufacture.

3. A method for providing one or more leads for one or more products or services for one or more customers to one or more sellers as in claim 1 further comprising the step of:
determining said amount to pay to said one or more customers that increases with a number of said characteristics of said at least one of the products or services that said one or more customers intends to purchase within a time period.

4. A method for providing one or more leads for one or more products or services for one or more customers to one or more sellers as in claim 1 further comprising the step of:
determining said amount to pay to said one or more customers that increases with an amount of detail of said characteristics of said at least one of the products or services that said one or more customers intends to purchase within a time period.

5. A method for providing one or more leads for one or more products or services for one or more customers to one or more sellers as in claim 1 wherein said step of determining a region within which said one or more customers intends to purchase said at least one product or service comprises the step of:
receiving said region within which said one or more customers intends to purchase said at least one product or service from said one or more customers from said one or more second computers through said one or more communication networks.

6. A method for providing one or more leads for one or more products or services for one or more customers to one or more sellers as in claim 1 wherein said step of determining a region within which said one or more customers intends to purchase said at least one product or service comprises the steps of:
determining a location of said one or more customers who intends to purchase said at least one product or service;
suggesting one or more suggested regions that are within a radius of said determined location of said one or more customers; and
receiving an indication that said one or more customers selected at least one of said one or more suggested regions.

7. A method for providing one or more leads for one or more products or services for one or more customers to one or more sellers as in claim 1 further comprising the steps of:
receiving an indication that said one or more customers purchased said at least one matching offered product or service within said region within said time period from said one or more second computers through said one or more communication networks to said one or more first computers;
requesting a payment for said at least one lead from said at least one seller of said at least one matching offered product or service within said region from said one or more first computers through said one or more communication networks to said one or more third computers;
receiving a request from said at least one seller of said at least one matching offered product or service within said region to view said purchase indication from said one or more third computers through one or more communication networks to said one or more first computers; and
receiving payment for said at least one lead from said at least one seller if said at least one seller accepts said purchase indication.

8. A method for providing one or more leads for one or more products or services for one or more customers to one or more sellers as in claim 1 further comprising the steps of:
entering said at least one customer into a lottery to win one or more prizes if said at least one customer purchases said at least one matching offered product or service within said region within said time period, and
transmitting an indication that said at least one customer has been entered into said lottery to said one or more second computers through said one or more communication networks.

9. An apparatus for providing one or more leads for one or more products or services for one or more customers to one or more sellers comprising:
one or more first computers, said one or more first computers having one or more input devices, at least one of said input devices:
receiving an indication that at least one of said customers intends to purchase at least one of the products or services within a time period, said indication comprising one or more characteristics of said at least one product or service that said at least one customer intends to purchase within said a time period;
said one or more first computers having one or more processors, at least one of said processors:
determining a region within which said at least one customer intends to purchase said at least one product or service; and
determining at least one offered product or service that is offered for sale within said region by at least one of said one or more sellers and that has one or more characteristics that matches at least one of said one or more characteristics of said at least one of the products or services that said at least one of said customers intends to purchase;
said one or more first computers having one or more output devices, at least one of said output devices:
transmitting a commitment to pay an amount to said at least one customer if an indication is received that said at least one of said customers purchased said at least one product or service within said region within said time period from said one or more first computers;
and
providing at least one lead to said at least one of said one or more sellers that is offering for sale within said region said at least one matching offered product or service, said lead identifying said at least one customer intending to purchase said at least one of the products or services.

10. An apparatus for providing, one or more leads for one or more products or services for one or more customers to one or more sellers as in claim 9 wherein said or more products or services is at least one of one or more members of a group consisting of a truck, a car, a motorcycle, an all-terrain vehicle, and a product or service that is required to be registered with a governmental agency upon transfer of ownership wherein said one or more characteristics includes one or more members of the group consisting of a model, a make, an options package, and a year of manufacture.

11. An apparatus for providing one or more leads for one or more products or services for one or more customers to one or more sellers as in claim 9, said at least one processor determining said amount to pay to said at least one customer that increases with a number of said characteristics of said at least one of the products or services that said at least one of said customers intends to purchase within a time period.

12. An apparatus for providing one or more leads for one or more products or services for one or more customers to one or more sellers as in claim 9, said at least one processor determining said amount to pay to said at least one customer that increases with an amount of detail of said characteristics of said at least one of the products or services that said at least one of said customers intends to purchase within a time period.

13. An apparatus for providing one or more leads for one or more products or services for one or more customers to one or more sellers as in claim 9 wherein said at least one processor:
receiving said region within which said at least one customer intends to purchase said at least one product or service from said at least one customer from said one or inure second computers through said one or more communication networks.

14. An apparatus for providing one or more leads for one or more products or services for one or more customers to one or more sellers as in claim 9 wherein said at least one processor:
determining a location of said at least one customer who intends to purchase said at least one product or service;
suggesting one or more suggested regions that are within a radius of said determined location of said one or more customers; and
receiving an indication that said one or more customers selected at least one of said one or more suggested regions.

15. An apparatus for providing one or more leads for one or more products or services for one or more customers to one or more sellers as in claim 9 wherein said at least input device receiving an indication that said one or more customers purchased said at least one matching offered product or service within said region within said time period; said at least one output device transmitting a request for payment for said at least one lead from said at least one seller of said at least one matching offered product or service within said region; and said at least one input device receiving payment for said at least one lead from said at least one seller if said at least one seller accepts said purchase indication.

16. An apparatus for providing one or more leads for one or more products or services for one or more customers to one or more sellers as in claim 9 wherein said at least one processor entering said at least one customer into a lottery to win one or more prizes if said at least one customer purchases said at least one matching product or service within said region within said time period, and said at least one output device transmitting an indication that said at least one customer has been entered into said lottery.

17. A non-transitory computer readable storage medium storing computer executable software code, the code for providing one or more leads for one or more products or services for one or more customers to one or more sellers, the code comprising:
code to receive an indication that at least one of said customers intends to purchase at least one of the products or services within a time period, said indication comprising one or more characteristics of said at least one product or service that said at least one customer intends to purchase within said a time period;
code to determine a region within which said at least one customer intends to purchase said at least one product or service;
code to transmit a commitment to pay an amount to said at least one customer if an indication is received that said at least one customer purchased said at least one product or service within said region within said time period;
code to determine at least one offered product or service that is offered for sale within said region by at least one of said one or more sellers and that has one or more characteristics that matches at least one of said one or more characteristics of said at least one of the products or services that said at least one of said customers intends to purchase; and
code to provide at least one lead to said at least one of said one more sellers that is offering for sale within said region said at least one matching offered product or service, said lead identifying said at least one customer intending to purchase said at least one of the products or services.

18. A non-transitory computer readable storage medium storing computer executable software code, the code for providing one or more leads for one or more products or services for one or more customers to one or more sellers as in claim 17, the code further comprising:
code to determine said amount to pay to said at least one customer that increases with a number of said characteristics of said at least one of the products or services that said at least one of said customers intends to purchase within a time period.

19. A non-transitory computer readable storage medium storing computer executable software code, the code for providing one or more leads for one or more products or services for one or more customers to one or more sellers as in claim 17, the code further comprising:
code to determine said amount to pay to said at least one customer that increases with an amount of detail of said characteristics of said at least one of the products or services that said at least one of said customers intends to purchase within a time period.

20. A non-transitory computer readable storage medium storing computer executable software code, the code for providing one or more leads for one or more products or services for one or more customers to one or more sellers as in claim 17, the code further comprising:
code to enter said at least one customer into a lottery to win one or more prizes if said at least one customer purchases said at least one matching offered product or service within said region within said time period, and
code to transmit an indication that said at least one customer has been entered into said lottery.
